(19) United States
(12) Patent Application Publication
(10) Pub. No.: US 2026/0233167 A1
(43) Pub. Date: Aug. 13, 2026

(54) METHOD AND DEVICE FOR REGENERATING INORGANIC POROUS GAS SEPARATION MEMBRANE

(71) Applicant: JGC CORPORATION, Kanagawa (JP)

(72) Inventors: Junya OKAZAKI, Kanagawa (JP); Hiroaki HASEGAWA, Kanagawa (JP); Tomoya NONOUE, Kanagawa (JP)

(73) Assignee: JGC CORPORATION, Kanagawa (JP)

(21) Appl. No.: 19/102,848

(22) PCT Filed: Oct. 31, 2022
(86) PCT No.: PCT/JP2022/040780

§ 371 Date: Feb. 10, 2025

(51) Int. Cl. B01D 65/02; B01D 69/04; B01D 71/02

(52) U.S. Cl. CPC B01D 65/02; B01D 69/04; B01D 71/021; B01D 71/027; B01D 71/0281; B01D 2321/18; B01D 2321/44

(57) ABSTRACT

Provided are a method of regenerating an inorganic porous gas separation membrane and a regeneration device for an inorganic porous gas separation membrane, which can restore the separation capability of the inorganic porous gas separation membrane in a simple and effective manner. A method of regenerating an inorganic porous gas separation membrane according to one embodiment includes bringing a cleaning fluid at a pressure of from 3 MPaG to 30 MPaG into contact with a used inorganic porous gas separation membrane containing at least a part of components of a treated gas.

### TECHNICAL FIELD

The present disclosure relates to a method of regenerating an inorganic porous gas separation membrane and a regeneration device for an inorganic porous gas separation membrane.

### Background Art

An inorganic porous gas separation membrane is used in pretreatment for separating nonhydrocarbon gas, such as carbon dioxide and nitrogen, included in natural gas and associated petroleum gas. In a separation process, nonhydrocarbon permeates an inorganic porous gas separation membrane and is separated from hydrocarbon that does not permeate an inorganic porous gas separation membrane. As an inorganic porous gas separation membrane, for example, an inorganic porous gas separation membrane in which a zeolite membrane is formed on a porous support is known.

When impurities in natural gas, such as propane, butane, pentane, and hexane, are adsorbed onto a surface or the inside of pores of an inorganic porous gas separation membrane, a flow passage of gas is closed. As a result, the separation capability, specifically the permeability and separation coefficient, of the inorganic porous gas separation membrane gradually decreases during a separation process. It has been known that a regeneration process of removing the impurities from the inorganic porous gas separation membrane is performed for such reason.

In Patent Literature 1 (WO 2018/207343 A1), the following is described. A first separation membrane module 1 and a second separation membrane module 2 are arranged in parallel with each other for a feed passage of a treated gas, and regeneration-gas flow passages 14 and 15 (24 and 25) that branch out from a permeating-gas flow passage 13 (23) of the separation membrane module 1 (2) and merge with a gas feed passage 21 (11) for feeding the treated gas to the separation membrane module 2 (1) are provided. Then, while the treated gas is fed to the separation membrane module 1, gas permeating the separation membrane module 1 is fed as regeneration gas to the separation membrane module 2 via the regeneration-gas flow passages 14 and 15, resulting in that the separation membrane module 2 is made non-operative, to be regenerated.

In Patent Literature 2 (WO 2020/136718 A1), the following is described. In order to separate nonhydrocarbon gas included in a treated gas, there is provided a regeneration-gas feed passage for feeding regeneration gas that is gas including moisture, to a primary side of an inorganic separation membrane in a separation membrane module. Thus, CO₂ gas including moisture is fed to the inorganic separation membrane, and subsequently, dry natural gas is fed, resulting in that the inorganic separation membrane can be regenerated.

In Patent Literature 3 (JP 2021-028054 A), there is described a method of regenerating a zeolite membrane complex that includes a zeolite membrane formed on a porous substrate and has been brought into contact with a gas mixture including a plurality of gas components to allow a part of the gas components to pass therethrough, the method being characterized in that the zeolite membrane complex is regenerated by being brought into contact with gas containing methane or ethane.

In Patent Literature 4 (JP 2017-148741 A), there is described a method of regenerating a used zeolite membrane complex that includes a zeolite membrane formed on a porous substrate and has been brought into contact with a treated gas to allow components having a high permeation rate in the treated gas to pass therethrough, the method including a step of changing gas flowing through the zeolite membrane complex from the treated gas to dry carbon dioxide gas, and a step of causing the dry carbon dioxide gas to permeate the used zeolite membrane complex.

In Non Patent Literature 1 (J. Membr. Sci., 2005, 251, 59-66), there is described the result of investigation on an influence of H₂O, N₂, C₂H₄, C₃H₈, or n-C₄H₁₀ as an impurity on CO₂/CH₄ separation in a SAPO-34 membrane formed on a stainless steel support.

In Non-Patent Literature 2 (J. Membr, Sci., 2015, 473, 201-209), it is described that, regarding two kinds of CHA zeolite membranes (SAPO-34, SSZ-13), propane reduces a permeation coefficient and exerts significant influence on separation, and the influence of propane is reversible when propane is removed from fed gas and the membrane is heated.

### CITATION LIST

### Patent Literature

[PTL 1] WO 2018/207343 A1
[PTL 2] WO 2020/136718 A1
[PTL 3] JP 2021-028054 A
[PTL 4] JP 2017-148741 A

### Non Patent Literature

[NPL 1] S. Li, G. Alvarado, R. D. Noble and J. L. Falconer, Effects of impurities on CO₂/CH₄ separations through SAPO-34 membranes, J. Membr. Sci., 2005, 251, 59-66.
[NPL 2] T. Wu, M. C. Diaz, Y. Zheng, R. Zhou, H. H. Funke, J. L. Falconer and R. D. Noble, Influence of propane on CO₂/CH₄ and N₂/CH₄ separations in CHA zeolite membranes, J. Membr. Sci., 2015, 473, 201-209.

### SUMMARY OF INVENTION

### Technical Problem

The present disclosure provides a method of regenerating an inorganic porous gas separation membrane and a regeneration device for an inorganic porous gas separation membrane, which can restore the separation capability of the inorganic porous gas separation membrane in a simple and effective manner.

### Solution to Problem

The inventors of the present invention have found that, by bringing a high-pressure cleaning fluid into contact with a used inorganic porous gas separation membrane, it is possible to regenerate the inorganic porous gas separation membrane, specifically restore the permeability of the used inorganic porous gas separation membrane.

The present disclosure encompasses the following aspects.

### Aspect 1

A method of regenerating an inorganic porous gas separation membrane, the method including bringing a cleaning fluid at a pressure of from 3 MPaG to 30 MPaG into contact with a used inorganic porous gas separation membrane containing at least a part of components of a treated gas.

### Aspect 2

The method according to aspect 1, wherein the inorganic porous gas separation membrane includes at least one selected from the group consisting of a zeolite membrane, a silica membrane, and a carbon membrane.

### Aspect 3

The method according to aspect 1 or 2, wherein the cleaning fluid is a supercritical fluid.

### Aspect 4

The method according to aspect 3, wherein the supercritical fluid is supercritical CO₂.

### Aspect 5

The method according to aspect 1 or 2, wherein the cleaning fluid is a gas mixture including hydrocarbon having 1 to 7 carbon atoms.

### Aspect 6

The method according to any one of aspects 1 to 5, wherein the cleaning fluid is at a temperature of from 0° C. to 250° C.

### Aspect 7

The method according to any one of aspects 1 to 6, wherein the inorganic porous gas separation membrane has a tubular shape including a treated-gas feed side, a non-permeation side, and a permeation side, and wherein the method further includes feeding the cleaning fluid to the treated-gas feed side or the non-permeation side of the inorganic porous gas separation membrane.

### Aspect 8

The method according to any one of aspects 1 to 6, wherein the inorganic porous gas separation membrane has a tubular shape including a treated-gas feed side, a non-permeation side, and a permeation side, and wherein the method further includes feeding the cleaning fluid to the permeation side of the inorganic porous gas separation membrane.

### Aspect 9

The method according to aspect 7 or 8, further including keeping a difference between a pressure on the treated-gas feed side and a pressure on the permeation side at 12 MPa or less.

### Aspect 10

The method according to any one of aspects 7 to 9, further including an initial pressure increasing step of feeding the cleaning fluid to both the treated-gas feed side or the non-permeation side and the permeation side.

### Aspect 11

A regeneration device for an inorganic porous gas separation membrane, the regeneration device including:
a gas separation membrane module including:
   a housing including a cleaning-fluid feed port and a used-cleaning-fluid discharge port; and
   an inorganic porous gas separation membrane accommodated in the housing; and

a cleaning-fluid feed device that is in fluid communication with the cleaning-fluid feed port.

### Advantageous Effects of Invention

According to the present invention, an inorganic porous gas separation membrane can be regenerated by a simple method, and the separation capability thereof can be restored effectively.

The description given above should not be regarded as disclosing all embodiments of the present invention and all advantages concerning the present invention.

### BRIEF DESCRIPTION OF DRAWINGS

FIG. 1 is an explanatory see-through perspective view for illustrating an inorganic porous gas separation membrane having a tubular shape according to one embodiment and a separation process using the inorganic porous gas separation membrane.

FIG. 2 is an explanatory see-through perspective view for illustrating a regeneration method according to one embodiment.

FIG. 3 is an explanatory see-through perspective view for illustrating a regeneration method according to another embodiment.

FIG. 4 is a schematic view for illustrating a regeneration device according to one embodiment.

### Description of Embodiments

Now, for the purpose of exemplifying representative embodiments of the present invention, the embodiments are described in detail with reference to the accompanying drawings. However, the present invention is not limited to the embodiments.

### Method of regenerating Inorganic Porous Gas Separation Membrane

A method of regenerating an inorganic porous gas separation membrane according to one embodiment includes bringing a cleaning fluid at a pressure of from 3 MPaG to 30 MPaG into contact with a used inorganic porous gas separation membrane containing at least a part of components of a treated gas.

The inorganic porous gas separation membrane is not limited to any particular membrane, and, for example, an inorganic porous gas separation membrane in which a gas separation membrane is formed on a porous support can be used.

Examples of the porous support include: ceramics, such as silica, α-alumina, γ-alumina, mullite, zirconia, titania, yttria, cordierite, silicon nitride, and silicon carbide; porous glasses such as shirasu porous glass; and porous sintered metals such as stainless steel. When the gas separation membrane is a zeolite membrane, ceramics including at least one kind selected from the group consisting of alumina, silica, and mullite is preferred. The ceramics including at least one kind selected from the group consisting of alumina, silica, and mullite firmly bonds to the zeolite membrane, and hence an inorganic porous gas separation membrane which is dense and has high separation performance can be formed. The porous support preferably includes alumina because the porous support has high corrosion resistance.

The average pore size of the porous support may be set to from 10 nm to 10 μm, and is preferably from 50 nm to 5 μm, more preferably from 100 nm to 3 μm. With the average pore size of the porous support being set to 10 nm or more, it is possible to reduce gas transfer resistance and improve the permeability to gas molecules. With the average pore size of the porous support being set to 10 μm or less, it is possible to suppress occurrence of defects or cracks in the gas separation membrane. The average pore size of the porous support is determined by a gas adsorption method.

In one embodiment, the inorganic porous gas separation membrane includes at least one selected from the group consisting of a zeolite membrane, a silica membrane, and a carbon membrane, as the gas separation membrane.

Examples of the zeolite membrane include zeolite membranes each having a crystal structure, for example: eight-membered ring zeolites, such as DDR, LTA, CHA, ERI, AEI, and RHO; ten-membered ring zeolites, such as MFI and FER; and twelve-membered ring zeolites, such as MOR, FAU, and BEA. In one embodiment, the zeolite membrane is a DDR-type zeolite membrane. The DDR-type zeolite membrane can be advantageously used in the separation process in which CO₂ is adopted as the permeating gas and hydrocarbon gas, particularly methane is adopted as the non-permeating gas.

Examples of the silica membrane include: tetraalkoxysilanes, such as tetramethoxysilane and tetraethoxysilane; trialkoxysilanes, such as ethyltrimethoxysilane, methyltrimethoxysilane, n-octyltriethoxysilane, and n-decyltrimethoxysilane; hexamethyldisiloxane; hexamethyldisilazane; cyclic siloxanes, such as octamethylcyclotetrasiloxane and decamethylcyclopentasiloxane; and porous silica membranes each formed of a silica source including a combination of two or more kinds thereof. Those porous silica membranes can be advantageously used in a separation process in which CO₂ is adopted as the permeating gas and in which hydrocarbon gas, particularly methane is adopted as the non-permeating gas.

Examples of the carbon membrane include porous carbon membranes each formed of a raw material including at least one kind of a polymer selected from the group consisting of a phenolic resin, a melamine resin, an epoxy resin, cellulose acetate, polyimide, polyamide, polyaramid, polyketone, polyether ketone, polypropylene oxide, polyphenylene oxide, and derivative thereof. Those porous carbon membranes can be advantageously used in the separation process in which CO₂ is adopted as the permeating gas and in which hydrocarbon gas, particularly methane is adopted as the non-permeating gas.

The average pore size of the gas separation membrane may be set to from 0.01 nm to 20 nm, and is preferably from 0.05 nm to 10 nm, more preferably from 0.1 nm to 1 nm. With the average pore size of the gas separation membrane being set to 0.01 nm or more, it is possible to improve the permeability to gas molecules. With the average pore size of the gas separation membrane being set to 20 nm or less, it is possible to improve the selective permeability of selectively allowing specific gas molecules to pass therethrough, as compared to other gas molecules. The average pore size of the gas separation membrane is determined by a capillary condensation method.

The gas separation membrane may be a single layer or a multilayer. In the case of a multilayer gas separation membrane, it is preferred that an average pore size of each layer be designed so as to increase from a surface in contact with the treated gas toward the porous support.

The film thickness of the gas separation membrane may be set to from 1 nm to 100 μm, preferably from 10 nm to 50 μm, more preferably from 50 nm to 5 μm. When the film thickness of the gas separation membrane is set to 1 nm or more, uniform separation performance may be imparted to the entire inorganic porous gas separation membrane. With the film thickness of the gas separation membrane being set to 100 μm or less, it is possible to suppress a drop in permeation pressure, to thereby suppress occurrence of cracks due to a difference in thermal expansion between the gas separation membrane and the porous support. In a case in which the gas separation membrane is multilayered, the “film thickness of the gas separation membrane” refers to a sum of respective film thicknesses of the layers.

The shape of the inorganic porous gas separation membrane is not particularly limited, and may be a flat membrane shape or a tube shape, such as a cylindrical shape or a rectangular tube shape. The inorganic porous gas separation membrane having a tube shape may have a single tube shape, or a honeycomb shape having a plurality of cells. In the case of a single-tube inorganic porous gas separation membrane, a gas separation membrane can be formed on one or both of an inner surface and an outer surface of the inorganic porous gas separation membrane. In the case of a honeycomb-shaped inorganic porous gas separation membrane, the inorganic porous gas separation membrane includes a honeycomb-shaped porous support that includes a plurality of cells partitioned off by porous partition walls extending from one end surface to another end surface in a lengthwise direction, and a gas separation membrane is formed on an inner wall of each of the cells. A gas separation membrane may be further formed on an outer surface of the porous support. A section of the cell can have a circular shape, an oval shape, or a polygonal shape.

The porous support and the gas separation membrane can be formed by methods known in the related-art. A zeolite membrane can be formed by, for example, hydrothermal synthesis using a precursor sol of the gas separation membrane and, as required, a seed crystal of the gas separation membrane, and heat treatment or firing treatment following hydrothermal synthesis. The silica membrane may be formed by, for example, coating using a silica sol serving as a hydrolysate of tetraethoxysilane, or firing treatment. The carbon membrane may be formed by, for example, coating using a solution including a polymer, such as a phenolic resin, a melamine resin, polyimide, or an epoxy resin, or carbide treatment.

The inorganic porous gas separation membrane can be used in the form of a gas separation membrane module in which the inorganic porous gas separation membrane is accommodated in a housing including a treated-gas feed port, a permeating-gas discharge port, and a non-permeating-gas discharge port. The gas separation membrane module may include a single inorganic porous gas separation membrane or a plurality of inorganic porous gas separation membranes. In one embodiment, the gas separation membrane module includes 2 to 30 tubular inorganic porous gas separation membranes. A plurality of gas separation membrane modules may be connected in series or in parallel, or may be connected in series and parallel combination. In any connection form, the number of gas separation membrane modules to be connected can be, for example, from 2 to 3,000.

In one embodiment, the inorganic porous gas separation membrane has a tubular shape including a treated-gas feed side, a non-permeation side, and a permeation side.

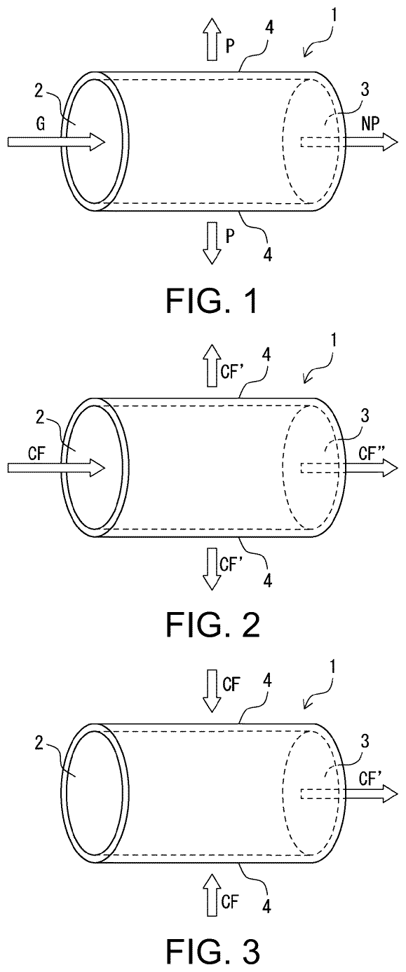

A tubular inorganic porous gas separation membrane 1 illustrated in FIG. 1 includes a treated-gas feed side 2, a non-permeation side 3, and a permeation side 4. In FIG. 1, the permeation side 4 is illustrated as an outer circumferential surface of the inorganic porous gas separation membrane 1. When a treated gas G including a plurality of gas components is fed from the treated-gas feed side 2, a part of the components included in the treated gas G permeates the inorganic porous gas separation membrane 1, is concentrated, and is taken out from the permeation side 4, as permeating gas P. The remaining components do not permeate the inorganic porous gas separation membrane 1, are concentrated, and are taken out from the non-permeation side 3, as non-permeating gas NP. Thus, the treated gas can be separated into the permeating gas P and the non-permeating gas NP.

Examples of the treated gas include a gas mixture of one or more kinds of hydrocarbon and inorganic gas, a gas mixture of one or more kinds of hydrocarbon and water, and a gas mixture of two or more kinds of hydrocarbon. Both factors of adsorptivity to the gas separation membrane included in the inorganic porous gas separation membrane and diffusivity in pores of the gas separation membrane affect a permeation rate of each of the components included in the treated gas through the inorganic porous gas separation membrane. Thus, whether or not it is easy for each component included in the above-mentioned gas mixtures to permeate the inorganic porous gas separation membrane depends on constituent components and a pore size of the gas separation membrane, and chemical affinity and a dynamic molecular size of each component included in the gas mixtures.

Examples of the hydrocarbon include a linear hydrocarbon having 1 to 8 carbon atoms, a branched hydrocarbon having 4 to 8 carbon atoms, and a cyclic hydrocarbon having 3 to 8 carbon atoms. Examples of the linear hydrocarbon having 1 to 8 carbon atoms include a saturated linear hydrocarbon selected from the group consisting of: methane, ethane, n-propane, n-butane, n-pentane, n-hexane, n-heptane, and n-octane; and an unsaturated linear hydrocarbon, such as ethylene, propylene, 1-butene, 2-butene, butadiene, 1-pentene, 2-pentene, 1,3-pentadiene, and acetylene. Examples of the branched hydrocarbon having 4 to 8 carbon atoms include: saturated branched hydrocarbons, such as isobutane and isopentane; and unsaturated branched hydrocarbons, such as isobutene, 2-methyl-1-butene, 2-methyl-2-butene, 3-methyl-1-butene, and isoprene. Examples of the cyclic hydrocarbon having 3 to 8 carbon atoms include: saturated cyclic hydrocarbons, such as cyclopropane, cyclobutane, cyclopentane, cyclohexane, cycloheptane, and cyclooctane; and unsaturated cyclic hydrocarbons, such as cyclopropene, cyclobutene, cyclopentene, cyclohexene, cycloheptene, cyclooctene, and cyclooctadiene.

Examples of the inorganic gas include gases, such as H₂, CO, CO₂, N₂, O₂, NO, carbon tetrafluoride, sulfur hexafluoride, He, and Ar.

Examples of the treated gas include natural gas containing CO₂ and methane. In a case of separating natural gas containing CO₂ and methane with use of an inorganic porous gas separation membrane including a DDR-type zeolite membrane, methane having a low permeation rate and CO₂ having a high permeation rate are concentrated on the non-permeation side and the permeation side, respectively. The natural gas contains, for example, ethane, propane, n-butane, n-hexane, or He as the other component.

Conditions for the separation process for the treated gas are not particularly limited. The temperature for the separation process is preferably from 20° C. to 300° C., more preferably from 25° C. to 250° C., still more preferably from 50° C. to 200° C. The feed pressure of the treated gas is preferably 1 MPaG or more, more preferably 2 MPaG or more, still more preferably 3 MPaG or more. An upper limit of the feed pressure of the treated gas is set to such an extent that the inorganic porous gas separation membrane is not broken, and normally, is set to 20 MPaG or less. A pressure difference between the non-permeation side and the permeation side (pressure on the non-permeation side-pressure on the permeation side) is preferably from 10 kPaG to 600 kPaG, more preferably from 50 kPaG to 300 kPaG. A feed rate of the treated gas can be set so as to fall within such a range that a linear velocity of the non-permeating gas is, for example, from 1.0 m/s to 15 m/s, preferably from 1.5 m/s to 12 m/s, more preferably from 2.0 m/s to 10 m/s. With the feed rate of the treated gas being set such that the linear velocity of the non-permeating gas is 15 m/s or less, it is possible to prevent breakage of the inorganic porous gas separation membrane.

During separation of the treated gas, at least a part of the components of the treated gas adheres to, and remains in, the surface or the inside of pores of the inorganic porous gas separation membrane, as impurities, and the pores are closed. As a result, the separation capability, specifically the permeability, of the inorganic porous gas separation membrane is degraded. For example, when natural gas is fed as the treated gas to the treated-gas feed side of the inorganic porous gas separation membrane including a DDR-type zeolite membrane, hydrocarbon, for example, n-hexane, n-heptane, or n-octane, adheres to the surface or the inside of pores of the DDR-type zeolite membrane, to degrade the separation capability.

The components of the treated gas that are included as impurities in the used inorganic porous gas separation membrane used in the separation process, even though in an extremely small amount, affect the separation capability of the inorganic porous gas separation membrane.

In the regeneration method according to one embodiment, a cleaning fluid at a pressure of from 3 MPaG to 30 MPaG is brought into contact with the used inorganic porous gas separation membrane, and thus impurities adhering to the membrane surface or the inside of pores diffuse throughout the cleaning fluid and are carried by the flow of the cleaning fluid, to be removed from the inorganic porous gas separation membrane. With the pressure of the cleaning fluid being set to from 3 MPaG to 30 MPaG, it is possible to promote separation of the impurities adhering to the surface or the inside of pores of the inorganic porous gas separation membrane from the inorganic porous gas separation membrane, or permeation of the impurities through the inorganic porous gas separation membrane, while suppressing damage to the inorganic porous gas separation membrane. Those actions can produce a significant regeneration effect.

It is preferred that the cleaning fluid to be brought into contact with the used inorganic porous gas separation membrane be a supercritical fluid. The supercritical fluid has a significant cleaning effect on impurities included in the inorganic porous gas separation membrane, for example, hydrocarbon having 4 or more carbon atoms. Examples of the supercritical fluid include CO₂, methane, ethane, propane, ethylene, and propylene. The supercritical fluid is preferably a single component. The supercritical fluid is preferably supercritical CO₂ or supercritical propane, more preferably supercritical CO₂. For example, the separation capability of a DDR-type zeolite membrane is not affected by CO₂ or propane, and thus use of supercritical CO₂ or supercritical propane as the cleaning fluid for a DDR-type zeolite membrane can keep the separation capability of the zeolite membrane at a high level also after regeneration. Further, the used supercritical CO₂ or supercritical propane to be recovered after regeneration is at a high pressure, and thus can be used directly as injection fluid for enhanced oil recovery (EOR) that is one of petroleum recovery technologies.

It is also preferred that the cleaning fluid to be brought into contact with the used inorganic porous gas separation membrane be a gas mixture including hydrocarbon having 1 to 7 carbon atoms. Examples of such gas mixture include a high-pressure natural gas, an associated gas, and process gases in petroleum refinery and petroleum chemical processes. The gas mixture preferably includes at least one kind selected from the group consisting of methane and ethane.

The gas mixture includes preferably 5 vol % to 95 vol % of a hydrocarbon having 1 to 7 carbon atoms.

The gas mixture may include any other component, such as water, N₂, H₂, O₂, He, or CO₂. The content of those components is typically 1 vol % or less, preferably 0.1 vol % or less.

The pressure of the cleaning fluid is from 3 MPaG to 30 MPaG, preferably from 7 MPaG to 25 MPaG, more preferably from 10 MPaG to 20 MPaG. In an embodiment in which the cleaning fluid is a supercritical fluid, a pressure of the cleaning fluid is equal to or more than a pressure at which the cleaning fluid becomes supercritical at a given temperature. For example, CO₂ becomes supercritical at 31° C. or more and at 7.28 MPaG or more. With the pressure of the cleaning fluid being set to 3 MPaG or more, it is possible to cause impurities adhering to the surface or the inside of pores of the inorganic porous gas separation membrane to quickly diffuse into the cleaning fluid. Meanwhile, when the cleaning fluid flows while passing through the inorganic porous gas separation membrane, impurities adhering to the surface of the inorganic porous gas separation membrane are pushed into the pores, which can promote separation of the impurities from the inorganic porous gas separation membrane. Those actions can enhance the regeneration effect. With the pressure of the cleaning fluid being set to 30 MPaG or less, it is possible to suppress damage to the inorganic porous gas separation membrane.

The temperature of the cleaning fluid is preferably from 0° C. to 250° C., more preferably from 20° C. to 220° C., still more preferably from 40° C. to 200° C. In an embodiment in which the cleaning fluid is a supercritical fluid, the temperature of the cleaning fluid is equal to or more than a temperature at which the cleaning fluid becomes supercritical at a given pressure. With the temperature of the cleaning fluid being set to 0° C. or more, it is possible to enhance the regeneration effect for the inorganic porous gas separation membrane. With the temperature of the cleaning fluid being set to 250° C. or less, it is possible to suppress damage to the inorganic porous gas separation membrane.

The temperature of the cleaning fluid is preferably ±30° C. with respect to a temperature of the separation process, more preferably ±20° C. with respect to a temperature of the separation process, still more preferably ±10° C. with respect to a temperature of the separation process. With the temperature of the cleaning fluid being set to +30° C. with respect to a temperature of the separation process, it is possible to shorten time taken to raise or lower the temperature of the inorganic porous gas separation membrane, which can enhance an operational efficiency of the inorganic porous gas separation membrane.

A feed rate of the cleaning fluid can be set so as to fall within such a range that a linear velocity of the used cleaning fluid discharged from the non-permeation side is, for example, from 1.0 m/s to 15 m/s, preferably from 1.5 m/s to 12 m/s, more preferably from 2.0 m/s to 10 m/s. With the feed rate of the cleaning fluid being set such that the linear velocity of the used cleaning fluid discharged from the non-permeation side is 1.0 m/s or more, it is possible to efficiently perform the regeneration process. With the feed rate of the cleaning fluid being set such that the linear velocity of the used cleaning fluid discharged from the non-permeation side is 15 m/s or less, it is possible to prevent breakage of the inorganic porous gas separation membrane.

Regeneration time is not limited to any particular time, the regeneration time is preferably from 1 hour to 96 hours, more preferably from 1 hour to 48 hours, still more preferably from 1 hour to 24 hours. The regeneration time can be set such that the permeability of the inorganic porous gas separation membrane is, for example, 60% or more of that before use, preferably 75% or more of that before use, more preferably 90% or more of that before use.

The regeneration process may be performed in, for example, the housing of the gas separation membrane module without removal of the inorganic porous gas separation membrane from a device for the separation process. The regeneration process may be performed in an external pressure vessel in which the inorganic porous gas separation membrane taken out from the housing of the gas separation membrane module is put.

The inorganic porous gas separation membrane has a tubular shape including the treated-gas feed side, the non-permeation side, and the permeation side, and it is preferred that the cleaning fluid be fed to the treated-gas feed side or the non-permeation side of the inorganic porous gas separation membrane. In an embodiment in which the cleaning fluid is fed to the treated-gas feed side, the cleaning fluid can be fed with the use of a feed line for the treated gas. In an embodiment in which the cleaning fluid is fed to the non-permeation side, the inorganic porous gas separation membrane in the vicinity of the non-permeation side in which a large amount of impurities are adsorbed can be cleaned with a fresh cleaning fluid, which can enhance an efficiency in cleaning the entire inorganic porous gas separation membrane.

With reference to FIG. 2, a regeneration method according to this embodiment is described. A cleaning fluid CF is fed to the treated-gas feed side 2 of the tubular inorganic porous gas separation membrane 1. Impurities included in the inorganic porous gas separation membrane 1 are absorbed in the cleaning fluid CF, and used cleaning fluid CF′ including the impurities is discharged from the permeation side 4. Meanwhile, the cleaning fluid CF that has not passed through the inorganic porous gas separation membrane 1 is discharged from the non-permeation side 3, as used cleaning fluid CF″. A pressure of the used cleaning fluid CF″ is substantially equal to the feed pressure of the cleaning fluid CF, and also the purity of the used cleaning fluid CF″ hardly decreases from the purity of the cleaning fluid CF. The cleaning fluid CF may be fed from the non-permeation side 3, and the used cleaning fluid CF″ may be discharged from the treated-gas feed side 2. Also in this case, the used cleaning fluid CF′ including the impurities is discharged from the permeation side 4.

The inorganic porous gas separation membrane has a tubular shape including the treated-gas feed side, the non-permeation side, and the permeation side, and it is also preferred that the cleaning fluid be fed to the permeation side of the inorganic porous gas separation membrane. In an embodiment in which the cleaning fluid is fed to the permeation side, the cleaning fluid flows toward the inside of the tubular inorganic porous gas separation membrane. Thus, in the case of a single-tube inorganic porous gas separation membrane in which the gas separation membrane is formed in the inner surface of the inorganic porous gas separation membrane, or in the case of a honeycomb-shaped inorganic porous gas separation membrane, impurities adhering to the surface of the gas separation membrane can be quickly removed without being pushed into pores, which results in enhancing an efficiency in regenerating the inorganic porous gas separation membrane.

With reference to FIG. 3, a regeneration method according to this embodiment is described. The cleaning fluid CF is fed to the permeation side 4 of the tubular inorganic porous gas separation membrane 1. Impurities included in the inorganic porous gas separation membrane 1 are absorbed in the cleaning fluid CF, and the used cleaning fluid CF′ including the impurities passes through the inside of the inorganic porous gas separation membrane 1 and is discharged from the non-permeation side 3. The used cleaning fluid CF′ may be discharged from the treated-gas feed side 2, or may be discharged from both the non-permeation side 3 and the treated-gas feed side 2.

It is preferred that a difference in pressure between the treated-gas feed side and the permeation side be kept at 12 MPa or less. Accordingly, it is possible to suppress damage to the inorganic porous gas separation membrane. The difference in pressure between the treated-gas feed side and the permeation side is more preferably 10 MPa or less, still more preferably 8 MPa or less. Typically, the pressure on the treated-gas feed side and the pressure on the non-permeation side are equal to each other.

In a case in which the cleaning fluid is a supercritical fluid, it is preferred that both the pressure on the treated-gas feed side and the pressure on the permeation side be equal to or more than a pressure at which the cleaning fluid can be kept in a supercritical state. This enables achievement of a high regeneration efficiency while suppressing damage to the inorganic porous gas separation membrane due to a phase change that may occur during passage of the cleaning fluid through the inorganic porous gas separation membrane.

It is preferred that the regeneration method further include an initial pressure increasing step of feeding the cleaning fluid to both the treated-gas feed side or the non-permeation side and the permeation side. This can shorten time taken to reach a regeneration pressure. After the initial pressure increasing step, when the regeneration process is started, the amount of the cleaning fluid fed to the treated-gas feed side or the non-permeation side, or to the permeation side is reduced, or alternatively, the feed of the cleaning fluid is stopped.

When the cleaning fluid is fed to the treated-gas feed side or the non-permeation side, a pressure of the used cleaning fluid discharged from the non-permeation side or the treated-gas feed side is substantially equal to the feed pressure of the cleaning fluid, and also the purity of the used cleaning fluid hardly decreases from that before use. Consequently, in those embodiments, the used cleaning fluid can be recycled and used again in the regeneration process.

When the cleaning fluid is fed to the treated-gas feed side or the non-permeation side, impurities are included in the used cleaning fluid discharged from the permeation side. When the cleaning fluid is fed to the permeation side, impurities are included in the used cleaning fluid discharged from the treated-gas feed side or the non-permeation side. When a plurality of gas separation membrane modules are connected in series, the amount of impurities included in a used inorganic porous gas separation membrane accommodated in a gas separation membrane module on a downstream side is typically smaller than the amount of impurities included in a used inorganic porous gas separation membrane accommodated in a gas separation membrane module on an upstream side. Thus, the used cleaning fluid coming out of the inorganic porous gas separation membrane on the downstream side in the regeneration process can also be recycled as the cleaning fluid for the regeneration process for the inorganic porous gas separation membrane on the upstream side.

In one embodiment, the used cleaning fluid can be employed in another process. For example, when the cleaning fluid is supercritical CO₂ or supercritical propane, the used cleaning fluid can be employed as injection fluid for EOR. In some business facilities that conduct EOR, supercritical CO₂ and supercritical propane can be produced in the same place as that in which EOR is conducted. Thus, a cost for production and transportation of the cleaning fluid is reduced, thereby enabling efficiently performing both regeneration of inorganic porous gas separation membranes and EOR at lower cost.

### Regeneration Device for Inorganic Porous Gas Separation Membrane

A regeneration device for an inorganic porous gas separation membrane according to one embodiment includes a gas separation membrane module and a cleaning-fluid feed device. The gas separation membrane module includes: a housing including a cleaning-fluid feed port and a used-cleaning-fluid discharge port; and an inorganic porous gas separation membrane accommodated in the housing. The cleaning-fluid feed device is in fluid communication with the cleaning-fluid feed port.

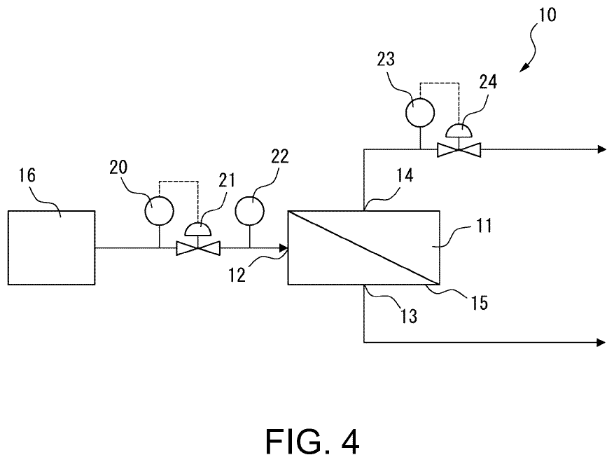

In FIG. 4, a regeneration device according to one embodiment is schematically illustrated. A regeneration device 10 includes a gas separation membrane module 11 and a cleaning-fluid feed device 16. The gas separation membrane module 11 includes: a housing 15 including a cleaning-fluid feed port 12 and used-cleaning-fluid discharge ports 13 and 14; and an inorganic porous gas separation membrane (not shown) accommodated in the housing 15. The cleaning-fluid feed port 12 of the housing 15 is in fluid communication with the cleaning-fluid feed device 16 via a pipe.

The regeneration device may be a part of a gas separation device or a device independent of the gas separation device. When the regeneration device is a part of the gas separation device, time elapsed until a start of the regeneration process can be shortened. When the regeneration device is an independent device, operation of the gas separation device is not required to be stopped and can be performed in parallel with the regeneration process.

One cleaning-fluid feed port may be provided as illustrated in FIG. 4, or two or more cleaning-fluid feed ports may be provided. Two used-cleaning-fluid discharge ports may be provided as illustrated in FIG. 4, or one or three or more used-cleaning-fluid discharge ports may be provided.

In FIG. 4, the pipe connecting the cleaning-fluid feed device 16 and the cleaning-fluid feed port 12 to each other is provided with a flowmeter 20, a flow-rate control valve 21, and a pressure gauge 22. Further, in FIG. 4, a pipe connected to the used-cleaning-fluid discharge port 14 is provided with a pressure gauge 23 and a pressure control valve 24. The flow-rate control valve 21 operates in association with a measured value of the flowmeter 20. The pressure control valve 24 operates in association with a measured value of the pressure gauge 23. The flowmeters, the flow-rate control valves, the pressure gauges, and the pressure control valves illustrated in FIG. 4 are mere examples, and the presence or absence, the type, the number, the position for arrangement, and the like of each of those measuring instruments, another instrument, and the valves in the present invention are not limited to those illustrated in FIG. 4. For example, the pipe connected to the used-cleaning-fluid discharge port 13 may be provided with a pressure gauge and a pressure control valve. Alternatively, a thermometer that measures a temperature of the used cleaning fluid may be provided in one or some of the pipes connected to the cleaning-fluid feed port 12 and the used-cleaning-fluid discharge ports 13 and 14.

As the gas separation membrane module of the regeneration device, a gas separation membrane module that is similar to the gas separation membrane module used in the separation process can be employed except that the inorganic porous gas separation membrane has been used.

In one embodiment, the gas separation membrane module of the regeneration device is the same as the gas separation membrane module used in the separation process. That is, in this embodiment, the gas separation membrane module used in the separation process is not detached or detached from the gas separation device and is used in the regeneration process, as the gas separation membrane module of the regeneration device. At this time, the used inorganic porous gas separation membrane can be regenerated on the spot without being taken out from the housing of the gas separation membrane module.

In another embodiment, the gas separation membrane module of the regeneration device may be prepared in such manner that the used inorganic porous gas separation membrane is taken out from the housing of the gas separation membrane module used in the separation process and is accommodated in another housing.

The gas separation membrane module of the regeneration device may include a single inorganic porous gas separation membrane or a plurality of inorganic porous gas separation membranes. In one embodiment, the gas separation membrane module of the regeneration device includes 2 to 30 tubular inorganic porous gas separation membranes. The plurality of gas separation membrane modules may be connected in series or in parallel, or may be connected in series and parallel combination. In any connection form, the number of gas separation membrane modules to be connected can be, for example, from 2 to 3,000.

In one embodiment, the housing of the gas separation membrane module used in the separation process includes a treated-gas feed port, a permeating-gas discharge port, and a non-permeating-gas discharge port. In this embodiment, the treated-gas feed port, the permeating-gas discharge port, or the non-permeating-gas discharge port of the housing can be employed as the cleaning-fluid feed port or the used-cleaning-fluid discharge port of the housing of the gas separation membrane module of the regeneration device. For example, the following correspondence relationships therebetween are possible, though not limited thereto.
(1) The treated-gas feed port is employed as the cleaning-fluid feed port 12, the non-permeating-gas discharge port is employed as the used-cleaning-fluid discharge port 13, and the permeating-gas discharge port is employed as the used-cleaning-fluid discharge port 14.
(2) The non-permeating-gas discharge port is employed as the cleaning-fluid feed port 12, the treated-gas feed port is employed as the used-cleaning-fluid discharge port 13, and the permeating-gas discharge port is employed as the used-cleaning-fluid discharge port 14.
(3) The permeating-gas discharge port is employed as the cleaning-fluid feed port 12, the treated-gas feed port is employed as the used-cleaning-fluid discharge port 13, and the non-permeating-gas discharge port is employed as the used-cleaning-fluid discharge port 14. In this case, one of the treated-gas feed port and the non-permeating-gas discharge port may be closed and fail to function as the used-cleaning-fluid discharge port.

Examples of the cleaning-fluid feed device include a supercritical CO₂ production apparatus, a high-pressure gas tank, a CO₂ pipeline and ancillary facilities thereof, and production facilities for a natural gas or an associated petroleum gas.

The used-cleaning-fluid discharge port may be temporally connected to the cleaning-fluid feed device. Under this state, the initial pressure increasing step described above may be performed by a feed of the cleaning fluid to the used-cleaning-fluid discharge port.

With the use of the regeneration device 10 illustrated in FIG. 4, the regeneration process can be performed in accordance with, for example, the following procedure. In the following description, the cleaning-fluid feed port 12 corresponds to the treated-gas feed port, the used-cleaning-fluid discharge port 13 corresponds to the non-permeating-gas discharge port, and the used-cleaning-fluid discharge port 14 corresponds to the permeating-gas discharge port. That is, with regard to the tubular inorganic porous gas separation membrane, the cleaning-fluid feed port 12 corresponds to the treated-gas feed side, the used-cleaning-fluid discharge port 13 corresponds to the non-permeation side, and the used-cleaning-fluid discharge port 14 corresponds to the permeation side.

The cleaning fluid is fed from the cleaning-fluid feed device 16 to the cleaning-fluid feed port 12. The amount of the cleaning fluid being fed is monitored by the flowmeter 20, and the flow-rate control valve 21 is opened or closed, or a degree of opening of the flow-rate control valve 21 is adjusted, in accordance with a measured value of the flowmeter 20. Thus, a flow rate of the cleaning fluid is controlled. The pressure of the cleaning fluid in the gas separation membrane module 11 may be controlled by control over the flow rate of the cleaning fluid. The pressure gauges 22 and 23 monitor the pressures of the treated-gas feed side and the permeation side of the inorganic porous gas separation membrane, respectively. The pressure control valve 24 is opened or closed, or a degree of opening of the pressure control valve 24 is adjusted, in accordance with a measured value of the pressure gauge 23 and, as required, a measured value of the pressure gauge 22. Thus, the pressure of the cleaning fluid in the gas separation membrane module 11 is controlled. In this manner, the feed rate and pressure of the cleaning fluid are controlled within a range appropriate to regeneration of the inorganic porous gas separation membrane.

The cleaning fluid fed from the cleaning-fluid feed port 12 flows from the treated-gas feed side of the used inorganic porous gas separation membrane. A part of the cleaning fluid permeates the inorganic porous gas separation membrane while absorbing impurities included in the used inorganic porous gas separation membrane, and flows out from the used-cleaning-fluid discharge port 14 while including the impurities. The remainder of the cleaning fluid flows out from the used-cleaning-fluid discharge port 13. Thus, the used inorganic porous gas separation membrane is regenerated.

### EXAMPLES

Specific embodiments of the present disclosure are exemplified by way of Examples below, but the present invention is not limited thereto. The terms “part(s)” and “%” are by mass unless otherwise specified.

### Example 1

Regeneration of a used inorganic porous gas separation membrane using supercritical CO₂ was tested in accordance with the following procedure.

As the inorganic porous gas separation membrane, an inorganic porous gas separation membrane, in which a DDR-type zeolite membrane was formed as a gas separation membrane on an inner wall of each of cells in a cylindrical-honeycomb-shaped porous support having an outer diameter of 30 mm and a length of 160 mm and including 30 cells, was used.

The inorganic porous gas separation membrane was inserted into a pressure vessel. At an operating temperature of 90° C., CO₂ at a pressure of 0.5 MPaG was fed from a treated-gas feed port of the pressure vessel, and the CO₂ permeability (a flow rate of permeating CO₂) with a pressure on a permeation side set to 0 MPaG was measured. The flow rate of permeating CO₂ was measured using a mass flowmeter. The CO₂ permeability at that time was set to 100% (reference value).

In order to reduce the performance of the inorganic porous gas separation membrane, a CO₂/CH₄ gas mixture (CO₂/CH₄=50/50 (volume ratio)) including 3,000 ppm to 5,000 ppm of hexane was fed at an operating temperature of 90° C. under the conditions of a pressure on a treated-gas feed side of 4.8 MPaG and a pressure on a permeation side of 0.7 MPaG. After that, CO₂ permeability of a used inorganic porous gas separation membrane was measured at an operating temperature of 90° C., under the conditions of a pressure on the feed side of 0.5 MPaG and a pressure on the permeation side of 0 MPaG.

Subsequently, at an operating temperature of 90° C., supercritical CO₂ at a pressure of from 8.0 MPaG to 8.2 MPaG was fed from the treated-gas feed port of the pressure vessel, and the pressure on the permeation side was kept at 7.28 MPaG or more for two hours so that also CO₂ on the permeation side could be placed in a supercritical state. Thus, the inorganic porous gas separation membrane was regenerated. After that, at an operating temperature of 90° C., the CO₂ permeability of the inorganic porous gas separation membrane regenerated under the condition of the pressure on the feed-side pressure of 0.5 MPaG and the pressure on the permeation-side pressure of 0 MPaG was measured.

In the case of the used inorganic porous gas separation membrane through which a gas mixture of CO₂/CH₄ including hexane had passed, the CO₂ permeability decreased to 35% of the reference value.

In the case of the inorganic porous gas separation membrane subjected to a regeneration process in which supercritical CO₂ was fed from the treated-gas feed side and the membrane was held under an environment of supercritical CO₂ for two hours, the CO₂ permeability was restored to 63% of the reference value. No breakage of the inorganic porous gas separation membrane was observed.

It will be apparent to those skilled in the art that various modifications can be made in the embodiments and Examples described above without departing from the basic principles of the present invention. Further, it will also be apparent to those skilled in the art that various improvements and modifications of the present invention can be made without departing from the gist and the scope of the present invention.

### Industrial Applicability

The method of the present disclosure can be suitably applied to regeneration of a used inorganic porous gas separation membrane.

### Reference Signs List

1 inorganic porous gas separation membrane
2 treated-gas feed side
3 non-permeation side
4 permeation side
G treated gas
P permeating gas
NP non-permeating gas
CF cleaning fluid
CF′ used cleaning fluid
CF″ used cleaning fluid
10 regeneration device
11 gas separation membrane module
12 cleaning-fluid feed port
13, 14 used-cleaning-fluid discharge port
15 housing
16 cleaning-fluid feed device
20 flowmeter
21 flow-rate control valve
22, 23 pressure gauge
24 pressure control valve

To the Claims:

1. A method of regenerating an inorganic porous gas separation membrane having a flat membrane shape or a tube shape, the method comprising bringing a cleaning fluid at a pressure of from 5 MPaG to 30 MPaG into contact with a used inorganic porous gas separation membrane containing at least a part of components of a treated gas.

2. The method according to claim 1, wherein the inorganic porous gas separation membrane includes at least one selected from the group consisting of a zeolite membrane, a silica membrane, and a carbon membrane.

3. The method according to claim 1, wherein the cleaning fluid is a supercritical fluid.

4. The method according to claim 3, wherein the supercritical fluid is supercritical CO_{2.}

5. The method according to claim 1, wherein the cleaning fluid is a gas mixture including hydrocarbon having 1 to 7 carbon atoms.

6. The method according to claim 1, wherein the cleaning fluid is at a temperature of from 0° C. to 250° C.

7. The method according to claim 1,
wherein the inorganic porous gas separation membrane has a tubular shape including a treated-gas feed side, a non-permeation side, and a permeation side, and
wherein the method further comprises feeding the cleaning fluid to the treated-gas feed side, the non-permeation side, or the permeation side of the inorganic porous gas separation membrane.

8. (canceled)

9. The method according to claim 7, further comprising keeping a difference between a pressure on the treated-gas feed side and a pressure on the permeation side at 12 MPa or less.

10. The method according to claim 7, further comprising an initial pressure increasing step of feeding the cleaning fluid to both the treated-gas feed side or the non-permeation side and the permeation side.

11. A regeneration device for an inorganic porous gas separation membrane having a flat membrane shape or a tube shape, the regeneration device comprising:
a gas separation membrane module including:
a housing including a cleaning-fluid feed port and a used-cleaning-fluid discharge port; and
an inorganic porous gas separation membrane accommodated in the housing; and
a cleaning-fluid feed device that is in fluid communication with the cleaning-fluid feed port.

12. The method according to claim 1, wherein the inorganic porous gas separation membrane is a tubular inorganic porous gas separation membrane, and the tubular inorganic porous gas separation membrane is a single-tube inorganic porous gas separation membrane or a honeycomb-shaped inorganic porous gas separation membrane.

13. The regeneration device according to claim 11, wherein the inorganic porous gas separation membrane is a tubular inorganic porous gas separation membrane, and the tubular inorganic porous gas separation membrane is a single-tube inorganic porous gas separation membrane or a honeycomb-shaped inorganic porous gas separation membrane.
